(19) United States
(12) Patent Application Publication
(10) Pub. No.: US 2026/0203436 A1
(43) Pub. Date: Jul. 16, 2026

(54) DATA MODEL OF SCHEMA LEVEL OBJECT FOR ASSOCIATING ADMINISTRATION AND MANAGEMENT IDENTITIES WITH DATA ASSETS

(71) Applicant: Snowflake Inc., Bozeman, MT (US)

(72) Inventors: Raja Suresh Krishna Balakrishnan, Fremont, CA (US); David Schultz, Piedmont, CA (US); Jian Xu, San Jose, CA (US); Yanshu Zhao, Kirkland, WA (US)

(21) Appl. No.: 19/025,920

(22) Filed: Jan. 16, 2025

(51) Int. Cl. G06F 21/62; G06F 16/2455

(52) U.S. Cl. CPC G06F 21/6227; G06F 16/2455

(57) ABSTRACT

This disclosure provides methods and techniques of using a data model to provide contact information for associating administration and management identities with data assets. An example method includes receiving a query request from a user for a first data object within a multi-tenant cloud-based data environment. The method further includes determining an absence of an access permission associated with the user based on security policies of the first data object. The method then identifies a second data object (e.g., a contact or contact object data model) associated with the first data object. The second data object includes communication information of an administrator (e.g., an owner, an assigned administrator, a system manager, or an inherent administrator, etc.) that has authority to grant the access permission to the user. The method further includes providing the communication information of the second data object to the user.

### FIELD

The present disclosure relates to databases and, more specifically, to managing data objects in a cloud-based database system.

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Different database storage systems may be used for storing different types of content, such as bibliographic, full text, numeric, and/or image content. Further, in computing, different database systems may be classified according to the organization approach of the database. There are many different types of databases, including relational databases, distributed databases, cloud databases, object-oriented and others.

Some database objects (also referred to herein as “data objects” or simply as “objects”) have dependencies on other database objects. Object dependencies can be created and destroyed by data defining language (DDL) operations on a referencing object. For example, if a view V refers to a table T using its definition, we say the V is depending on the table T. In this case, the view V is referred to as a “referencing object” and table T is referred to as a “referenced object.”.

Databases are used by various entities and companies for storing information that may need to be accessed or analyzed. In an example, a retail company may store a listing of all sales transactions in a database. The database may include information about when a transaction occurred, where it occurred, a total cost of the transaction, an identifier and/or description of all items that were purchased in the transaction, and so forth. The same retail company may also store, for example, employee information in that same database that might include employee names, employee contact information, employee work history, employee pay rate, and so forth. Depending on the needs of this retail company, the employee information and the transactional information may be stored in different tables of the same database. The retail company may have a need to “query” its database when it wants to learn information that is stored in the database. This retail company may want to find data about, for example, the names of all employees working at a certain store, all employees working on a certain date, all transactions for a certain product made during a certain time frame, and so forth.

In a multi-tenant cloud-based database system, many data owners do not widely grant access to data assets. Data owners often grant minimal privileges for relevant data users only, for them to discover the existence some data asset, and require separate access requests from the data users for specific access permissions or privileges. Very often, without access privileges or permissions, the data users may not discover the available data assets in the first place. In some cases, the data users might discover data assets by association from other accessible data assets, but would not have means to request access permissions from the data owners. As such, the data users are unable to request access permissions even if the data owners might be willing to grant such requests.

### BRIEF DESCRIPTION OF THE DRAWINGS

The present disclosure will be understood more fully from the detailed description given below and from the accompanying drawings of various embodiments of the disclosure.

FIG. 1 illustrates an example multi-tenant cloud-based data environment that includes a cloud-based database system, in accordance with aspects of this disclosure.

FIG. 2 is a block diagram illustrating components of a multi-tenant service manager, in accordance with aspects of this disclosure.

FIG. 3 is a block diagram illustrating components of an execution platform of the cloud-based database system of FIG. 1, in accordance with aspects of this disclosure.

FIG. 4 is a block diagram illustrating aspects of a dependency management system in tracking object dependencies in the cloud-based database system, in accordance with aspects of this disclosure.

FIG. 5 is a block diagram illustrating further aspects of the dependency management system in tracking object dependencies in the cloud-based database system, in accordance with aspects of this disclosure.

FIG. 6 is a block diagram illustrating additional aspects of a dependency management system in tracking object dependencies in the cloud-based database system, in accordance with aspects of this disclosure.

FIGS. 7 and 8 are flow diagrams illustrating operations in performing a method for granting data user permissions using a contact data model, in accordance with aspects of this disclosure.

FIG. 9 illustrates a block diagram of an example computing device that may perform one or more of the operations described herein, in accordance with aspects of this disclosure.

### DETAILED DESCRIPTION

Aspects of the present disclosure provide systems, methods, and devices for managing a multi-tenant cloud-based database system. An example method includes receiving a query request from a user for a first data object within a multi-tenant cloud-based data environment, the query request identifying at least one schema-level object stored within a schema. The method further includes determining an absence of an access permission associated with the user based on security policies of the first data object. The method then identifies a second data object (e.g., a contact or contact object data model) associated with the first data object. The second data object includes communication information of an administrator (e.g., an owner, an assigned administrator, a system manager, or an inherent administrator, etc.) that has authority to grant the access permission to the user. The method further includes providing the communication information of the second data object to the user.

In some cases, the method further includes receiving, from the administrator, a grant of the access permission for the first data object of the query request. The access permission is then validated based on security and compliance policies applicable to the first data object. The method includes executing the query upon successful validation of the access permission. The result of the first data object per the query request is then returned to the user. The second data object may be a schema-level object, which is similar to but different from tags or policies. The second data object may be separately created with properties including contact information for each purpose related administrators (e.g., owner, manager, tech support, etc.).

A cloud-based database system (e.g., Snowflake Horizon Catalog) provides comprehensive governance and discovery solution for data providers and users. The cloud-based database system supports built-in compliance, security, privacy, discovery, and collaboration capabilities, enabling organizations to effectively manage and utilize their data, applications, and models. For example, the cloud-based database facilitates data protection and auditing through data lineage visualization, data quality monitoring, and object tagging to identify and track sensitive information. The cloud-based database provides end-to-end encryption and authentication methods at different levels. The database implements advanced privacy policies including aggregation and projection policies, differential privacy, and data clean rooms, to enable secure collaboration on sensitive data. The cloud-based database enhances data discoverability with machine-learning powered object descriptions, universal search, and internal marketplaces to allow users to efficiently find and access relevant data, applications, and models. As such, the cloud-based database facilitates secure data sharing with organizations and external partners through organizational listings and/or internal marketplaces.

The present disclosure provides methods and processes to improve the cloud-based database system to allow unauthorized users to seek permissions from data owners and/or administrators. For example, this disclosure introduces a data model of schema level object for associating administration and management identities with data assets. When users have not been granted access or privileges to access certain data assets, conventionally, the users would not have information regarding who has the power to grant the access to the data assets within the cloud-based database system. According to aspects of this disclosure, a contact object data model is introduced data users to know who to contact to request privileges on the object they are interested in. The contact object data model helps in the situations where the technical owner of the object is not the business owner of the object of interest. Additionally, multiple parties being involved in the approval process may be common. To reduce the obscurity of the conventional system, the contact object data model provides communication information for users to know their data, who to contact, how to contact, and what services the data owners, administrators, or management may provide.

Very often, data owners are comfortable granting just enough privileges for relevant data users to discover the existence of the data asset, and expect data users to request access with appropriate justifications to use the data asset. Data owners may grant or deny access to the requested data asset based on their discretion. In addition to this primary user journey that requires contact information associated with objects, the data users may need to contact other users or teams for various purposes such as subject matter expertise, technical support, and governance support. Furthermore, the contact information is as relevant for data objects as for non-data objects for use cases such as contact information on a cloud-based database account to send notifications from the database platform to the correct customer individual or team. The contact object data model herein enables the users to be informed about the administrators and management authorities associated with the data assets of interests, and empowers them to efficiently request access permissions when appropriate (e.g., according to assigned privileges, permissions, security policies, etc.).

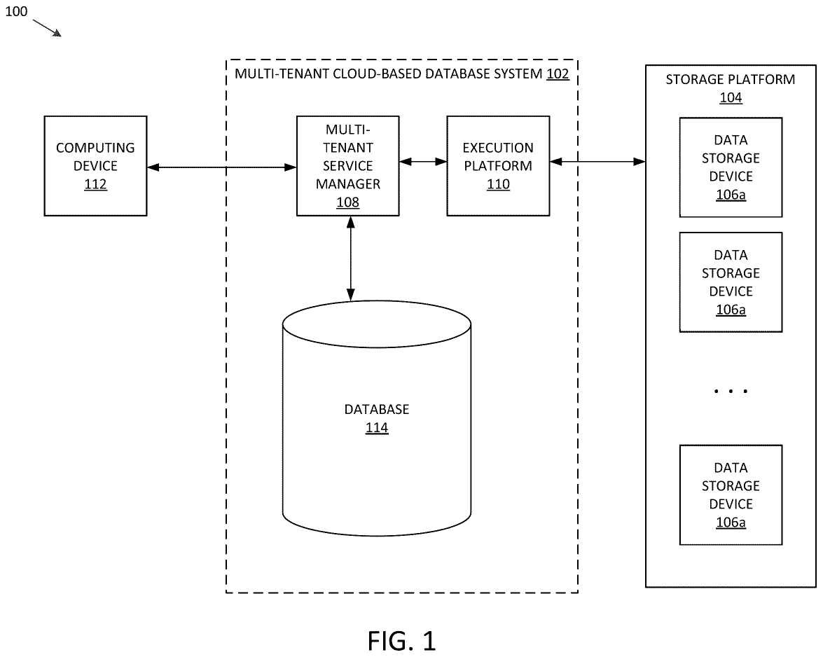

FIG. 1 illustrates an example multi-tenant cloud-based data environment 100 that includes a multi-tenant cloud-based database system 102, in accordance with aspects of this disclosure. As shown, the multi-tenant cloud-based data environment 100 includes the multi-tenant cloud-based database system 102 and a storage platform 104 (e.g., AWS®, Microsoft Azure Blob Storage®, or Google Cloud Storage®). The multi-tenant cloud-based database system 102 is used for reporting and analysis of integrated data from one or more disparate sources including storage devices 106a within the storage platform 104 (a=1, 2, . . . n, n being a natural number). The storage platform 104 includes multiple computing machines and provides on-demand computer system resources such as data storage and computing power to the multi-tenant cloud-based database system 102.

The multi-tenant cloud-based database system 102 includes a multi-tenant service manager 108, an execution platform 110, and a database 114. The multi-tenant cloud-based database system 102 hosts and provides data reporting and analysis services to multiple client accounts. Administrative users can create and manage identities (e.g., users, roles, and groups) and use permissions to allow or deny access to the identities to resources and services.

The multi-tenant service manager 108 coordinates and manages operations of the multi-tenant cloud-based database system 102. The multi-tenant service manager 108 also performs query optimization and compilation as well as managing clusters of computing services that provide compute resources (also referred to as “virtual warehouses”). The multi-tenant service manager 108 can support any number of client accounts, such as end users providing data storage and retrieval requests, system administrators managing the systems and methods described herein, and other components/devices that interact with multi-tenant service manager 108.

The multi-tenant service manager 108 is also in communication with a computing device 112. The computing device 112 corresponds to a user of one of the multiple client accounts supported by the multi-tenant cloud-based database system 102. In some embodiments, the multi-tenant service manager 108 does not receive any direct communications from the computing device 112 and only receives communications concerning jobs from a queue within the multi-tenant cloud-based database system 102.

The multi-tenant service manager 108 is also coupled to database 114, which is associated with the data stored in the multi-tenant cloud-based data environment 100. The database 114 stores data pertaining to various functions and aspects associated with the multi-tenant cloud-based database system 102 and its users. In some embodiments, the database 114 includes a summary of data stored in remote data storage systems as well as data available from a local cache. Additionally, the database 114 may include information regarding how data is organized in remote data storage systems (e.g., the storage platform 104) and the local caches. The database 114 allows systems and services to determine whether a piece of data needs to be accessed without loading or accessing the actual data from a storage device.

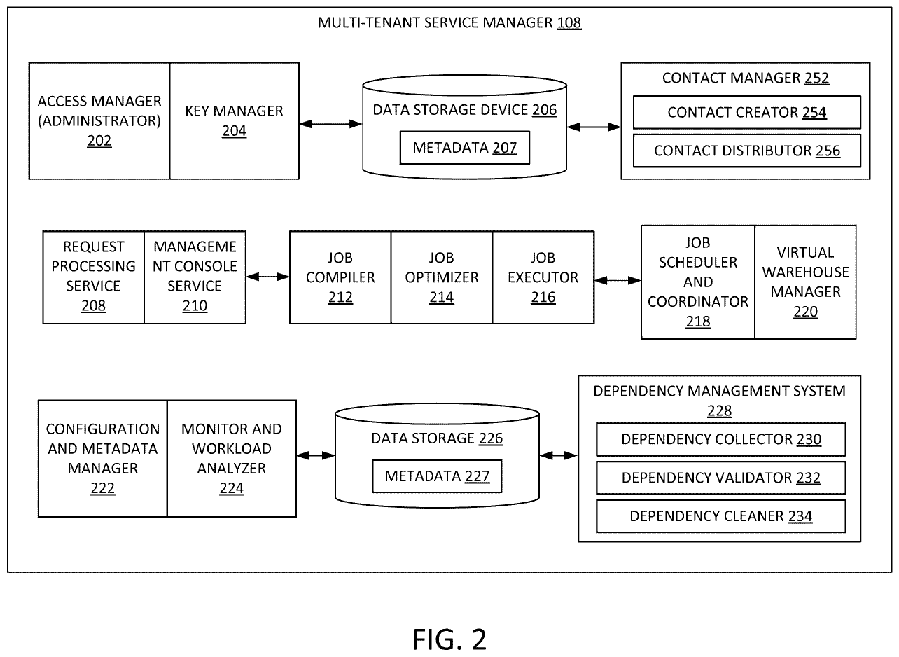

As discussed in detail below, the multi-tenant service manager 108 includes a dependency management system 228 of FIG. 2 to track object dependencies within the multi-tenant cloud-based data environment 100. The dependency management system monitors data definition language (DDL) commands/operations that are performed within the context of the multi-tenant cloud-based database system 102. The DDL operations may create, manipulate, and modify objects, including the contact object and other schema-level or account level objects, such as users, virtual warehouses, databases, schemas, tables, views, columns, functions, and stored procedures.

In some cases, the DDL operations may create object dependencies, for which the dependency management system 228 creates a dependency record for each detected dependency. The dependency management system also monitors DDL operations to detect changes to object dependencies and updates dependency records as needed. Dependency information included in dependency records can also be surfaced to users of the multi-tenant cloud-based database system 102 responsive to queries for such information.

The multi-tenant service manager 108 is further coupled to the execution platform 110, which provides multiple computing resources that execute various data storage and data retrieval tasks. The execution platform 110 is coupled to storage platform 104. The storage platform 104 includes multiple data storage devices 106a (a=1, 2, . . . , n). In some embodiments, the data storage devices 106a (a=1, 2, . . . , n) are cloud-based storage devices located in one or more geographic locations. For example, the data storage devices 106a (a=1, 2, . . . , n) may be part of a public cloud infrastructure or a private cloud infrastructure. The data storage devices 106a (a=1, 2, . . . , n) may be hard disk drives (HDDs), solid state drives (SSDs), storage clusters, Amazon S3TM storage systems, or any other data storage technology. Additionally, the storage platform 104 may include distributed file systems (e.g., Hadoop Distributed File Systems (HDFS)), object storage systems, and the like.

The execution platform 110 includes multiple compute nodes. A set of processes on a compute node executes a query plan compiled by the multi-tenant service manager 108. The set of processes can include: a first process to execute the query plan; a second process to monitor and delete database partition files using a least recently used (LRU) policy and implement an out of memory (00M) error mitigation process; a third process that extracts health information from process logs and status to send back to the multi-tenant service manager 108; a fourth process to establish communication with the multi-tenant service manager 108 after a system boot; and a fifth process to handle all communication with a compute cluster for a given job provided by the multi-tenant service manager 108 and to communicate information back to the multi-tenant service manager 108 and other compute nodes of the execution platform 110.

In some embodiments, communication links between elements of the multi-tenant cloud-based data environment 100 are implemented via one or more data communication networks. These data communication networks may utilize any communication protocol and any type of communication medium. In some embodiments, the data communication networks are a combination of two or more data communication networks (or sub-Networks) coupled to one another. In alternate embodiments, these communication links are implemented using any type of communication medium and any communication protocol.

As shown in FIG. 1, the data storage devices 106a (a=1, 2, . . . , n) are decoupled from the computing resources associated with the execution platform 110. This architecture supports dynamic changes to the multi-tenant cloud-based database system 102 based on the changing data storage/retrieval needs as well as the changing needs of the users and systems. The support of dynamic changes allows the multi-tenant cloud-based database system 102 to scale quickly in response to changing demands on the systems and components within the multi-tenant cloud-based database system 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The multi-tenant service manager 108, database 114, execution platform 110, and storage platform 104 are shown in FIG. 1 as individual discrete components. However, each of the multi-tenant service manager 108, database 114, execution platform 110, and storage platform 104 may be implemented as a distributed system (e.g., distributed across multiple systems/platforms at multiple geographic locations). Additionally, each of the multi-tenant service manager 108, database 114, execution platform 110, and storage platform 104 can be scaled up or down (independently of one another) depending on changes to the requests received and the changing needs of the multi-tenant cloud-based database system 102. Thus, in the described embodiments, the multi-tenant cloud-based database system 102 is dynamic and supports regular changes to meet the current data processing needs.

During typical operation, the multi-tenant cloud-based database system 102 processes multiple jobs determined by the multi-tenant service manager 108. These jobs are scheduled and managed by the multi-tenant service manager 108 to determine when and how to execute the job. For example, the multi-tenant service manager 108 may divide the job into multiple discrete tasks and may determine what data is needed to execute each of the multiple discrete tasks. The multi-tenant service manager 108 may assign each of the multiple discrete tasks to one or more nodes of the execution platform 110 to process the task. The multi-tenant service manager 108 may determine what data is needed to process a task and further determine which nodes within the execution platform 110 are best suited to process the task. Some nodes may have already cached the data needed to process the task and, therefore, be a good candidate for processing the task. Metadata stored in the database 114 assists the multi-tenant service manager 108 in determining which nodes in the execution platform 110 have already cached at least a portion of the data needed to process the task. One or more nodes in the execution platform 110 process the task using data cached by the nodes and, in some instances, data retrieved from the storage platform 104. It is desirable to retrieve as much data as possible from caches within the execution platform 110 because the retrieval speed is typically much faster than retrieving data from the storage platform 104.

As shown in FIG. 1, the multi-tenant cloud-based data environment 100 separates the execution platform 110 from the storage platform 104. In this arrangement, the processing resources and cache resources in the execution platform 110 operate independently of the data storage devices 106a (a=1, 2, . . . , n) in the storage platform 104. Thus, the computing resources and cache resources are not restricted to specific data storage devices 106a (a=1, 2, . . . , n). Instead, all computing resources and all cache resources may retrieve data from, and store data to, any of the data storage resources in the storage platform 104.

FIG. 1 has omitted the enumerated illustrations of various functional components that are not directly germane to conveying an understanding of this disclosure, as someone skilled in the art will readily recognize that the omitted functional components may be part of the multi-tenant cloud-based data environment 100 and facilitate additional functionalities. For example, someone skills in the art understands that the computing device 112 includes at least a processing device, a non-transitory memory, a storage device, and input/output interfaces or devices, which are not illustrated or described herein for clarity and brevity.

FIG. 2 is a block diagram illustrating components of the multi-tenant service manager 108, in accordance with aspects of this disclosure. As shown in FIG. 2, the multi-tenant service manager 108 includes an access manager 202 and a key manager 204 coupled to a data storage device 206, which stores metadata 207. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in storage platform 104). As used herein, the remote storage devices may also be referred to as “persistent storage devices” or “shared storage devices.”

The data storage device 206 communicates with the access manager (administrator 202, the key manager 204, and the contact manager 252. The contact manager 252 may perform the methods herein, such as the methods 700 and 800, to provide contact information to data users when the data users do not have access permissions to the data assets indicated in a query request. For example, when the multi-tenant service manager 108 receives a query request from a user for a first data object and determines that the data users do not have access permissions, the contact manager 252 identifies a contact object associated with the first data object. The contact object includes communication information of an administrator that has authority to grant the access permission to the data users. The contact manager 252 provides the communication information of the contact object to the data users.

The contact manager 252 includes at least a contact creator 254 and a contact distributor 256. The contact creator 254 enables data asset owners, database system managers, and/or administrators to create contact objects (e.g., recording or collecting the communication information). The contact distributor 256 associates the contact objects with other data objects managed by the multi-tenant service manager 108. In some cases, the contact distributor 256 and the dependency management system 228 operate in concert to associate the contact objects with other data objects, so that when data users discover a data asset beyond respective access privileges or permissions, the data users may access the associated contact objects based on dependency.

A request processing service 208 manages received data storage requests and data retrieval requests (e.g., jobs to be performed on database data). For example, the request processing service 208 may determine the data needed to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The multi-tenant service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the multi-tenant service manager 108.

A job scheduler and coordinator 218 sends received jobs to the appropriate services or systems for compilation, optimization, and dispatch to the execution platform 110. For example, jobs may be prioritized and processed in that prioritized order. In an embodiment, the job scheduler and coordinator 218 determines a priority for internal jobs that are scheduled by the multi-tenant service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the multi-tenant service manager 108 includes a configuration and metadata manager 222, which manages the information related to the data stored in the remote data storage devices and in the local caches (e.g., the caches in execution platform 110). The configuration and metadata manager 222 can use the metadata 227 (or 207) to determine which partitions need to be accessed to retrieve data for processing a particular task or job. A monitor and workload analyzer 224 oversees processes performed by the multi-tenant service manager 108 and manages the distribution of tasks (e.g., workload) across the virtual warehouses and execution nodes in the execution platform 110. The monitor and workload analyzer 224 also redistributes tasks, as needed, based on changing workloads throughout the multi-tenant cloud-based database system 102 and may further redistribute tasks based on a user (e.g., “external”) query workload. The execution platform 110 may also redistribute tasks based on a user (e.g., “external”) query workload. The configuration and metadata manager 222 and the monitor and workload analyzer 224 are coupled to a data store 226, which stores metadata 227. Data store 226 in FIG. 2 represents any data store within the multi-tenant cloud-based database system 102. For example, data store 226 may correspond to caches in execution platform 110, storage devices in storage platform 104, or any other storage device.

A dependency management system 228 of the multi-tenant service manager 108 is responsible for managing object dependencies within the multi-tenant cloud-based database system 102. The dependency management system 228 includes a dependency collector 230, a dependency validator 232, and a dependency cleaner 234. The dependency collector 230 monitors DDL operations performed within the multi-tenant cloud-based database system 102 to detect creation of object dependencies. The dependency collector 230 generates a dependency record for each detected object dependency. Each dependency record includes dependency information that describes the object dependency. A dependency record can, for example, include any one or more of: an identifier of the referenced object (e.g., an object name or other unique identifier), a parent database of the referenced object, a parent schema of the referenced object, a domain of the referenced object, an identifier of the referencing object (e.g., an object name or other unique identifier), a parent database of the referencing object, a parent schema of the referencing object, and a domain of the referencing object. Dependency records are maintained in one or more metadata repositories of the multi-tenant cloud-based database system 102, which can be included in the data store 226.

In addition, each dependency record can include an indication of a validity status for the corresponding object dependency. The status of an object' dependency can be valid or broken (invalid). Accordingly, a dependency record includes an indicator of the dependency being valid or broken. The dependency validator 232 is responsible for assessing the validity of object dependencies and maintaining an accurate status in corresponding dependency records. That is, the dependency validator 232 can change the status of a dependency record based on detecting a change to the status of the underlying dependency.

The dependency cleaner 234 is responsible for ensuring that the dependency information maintained in dependency records is up to date. In some instances, the dependency cleaner 234 can remove a dependency record from the database of dependency if the dependency record is no longer relevant to ongoing operations. Further details regarding the components of the dependency management system 228 are discussed below.

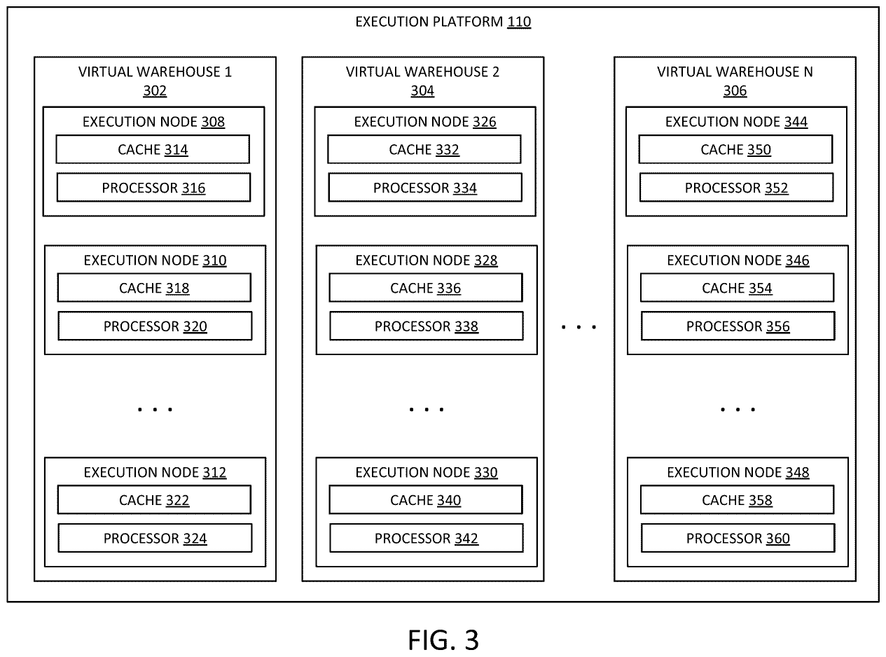

FIG. 3 is a block diagram illustrating components of the execution platform 110 of the cloud-based database system 102 of FIG. 1, in accordance with aspects of this disclosure. As shown in FIG. 3, the execution platform 110 includes multiple virtual warehouses, including virtual warehouse 1 (302), virtual warehouse 2 (304), through virtual warehouse N (306), wherein N represents a natural number (e.g., 1, 2, 3, . . . ). Each virtual warehouse 1-N includes multiple execution nodes that each include a data cache and a processor.

The virtual warehouses 1-N can execute multiple tasks in parallel by using the multiple execution nodes (308, 310, 312, 326, 328, 330, 344, 346, 348, . . . ). As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in storage platform 104).

Although each virtual warehouse 1-N shown in FIG. 3 includes multiple execution nodes, a particular virtual warehouse may include any number of execution nodes. Further, the number of execution nodes in a virtual warehouse is dynamic, such that new execution nodes are created when additional demand is present and existing execution nodes are deleted when they are no longer necessary.

Each virtual warehouse is capable of accessing any of the data storage devices 106a (a=1, 2, . . . , n) shown in FIG. 1. Thus, the virtual warehouses are not necessarily assigned to a specific data storage device 106a and, instead, can access data from any of the data storage devices 106a (a=1, 2, . . . , n) within the storage platform 104. Similarly, each of the execution nodes shown in FIG. 3 can access data from any of the data storage devices 106a (a=1, 2, . . . , n). In some embodiments, a particular virtual warehouse or a particular execution node may be temporarily assigned to a specific data storage device, but the virtual warehouse or execution node may later access data from any other data storage device.

In the example of FIG. 3, the virtual warehouse 1 (302) includes multiple execution nodes 308, 310, and 312. Execution node 308 includes a cache 314 and a processor 316. Execution node 310 includes a cache 318 and a processor 320. Execution node 312 includes a cache 322 and a processor 324. Each execution node 308, 310, and 312 is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 (304) includes multiple execution nodes 326, 328, and 330. Execution node 326 includes a cache 332 and a processor 334. Execution node 328 includes a cache 336 and a processor 338. Execution node 330 includes a cache 340 and a processor 342. Similar to the virtual warehouses 1 and 2, the virtual warehouse N (306) includes multiple execution nodes 344, 346, and 348. Execution node 344 includes a cache 350 and a processor 352. Execution node 346 includes a cache 354 and a processor 356. Execution node 348 includes a cache 358 and a processor 360. Each execution node 344, 346, and 348 is associated with processing one or more data storage and/or data retrieval tasks.

In some embodiments, the execution nodes shown in FIG. 3 are stateless with respect to the data that the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternate embodiments may include execution nodes containing any number of processors and any number of caches. Additionally, the caches may vary in size among the different execution nodes. The caches shown in FIG. 3 store, in the local execution node, data that was retrieved from one or more data storage devices in storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 302, 304, and 306 are associated with the same execution platform 110, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 308 and 310 on one computing platform at a geographic location and implements execution node 312 at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

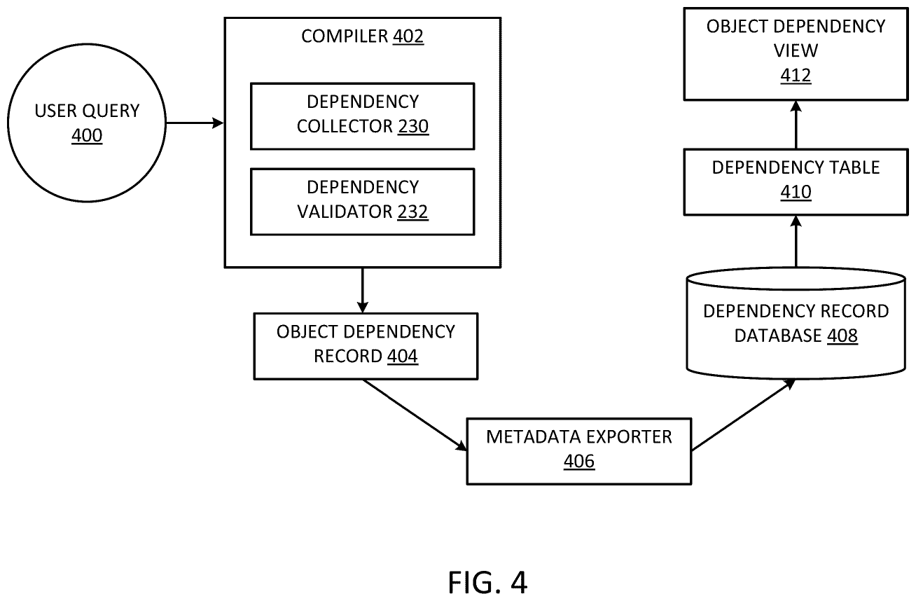

FIG. 4 is a block diagram illustrating aspects of the dependency management system 228 in the multi-tenant cloud-based database system 102, in accordance with aspects of this disclosure. As shown, a user query 400 is received by a compiler 402 of the multi-tenant service manager 108. The query 400 includes a command to create a first object (hereinafter referred to as a “referencing object”) with a dependency on a second object (hereinafter referred to as a “referenced object”). Object dependencies and contact objects may be used together to enhance data governance, security, and compliance. For example, contact objects introduced herein may be applied to other data objects (e.g., tables, views, columns, etc.) to provide contact information annotations. Contact objects may provide name and contact information (e.g., email address or the like) of an associated owner, administrator, manager, or the like. Object dependencies may track relationships between schema-level objects. For example, when contacts are applied to one object, the dependency chain helps propagate or enforce the governance policies associated with those contacts, providing data users convenient access to the communication information when needed. The dependency association maintains the consistent and compliant handling of data assets.

There are multiple types of object dependencies within the context of the multi-tenant cloud-based database system 102. For example, there are direct dependencies, by-Name object dependencies, and by-identifier object dependencies. With a direct dependency, a first object depends directly on a second object. With a by-Name object dependency, a first object refers to a second object by name. A by-Name dependency can depend on a database, schema, object name, or combinations thereof depending on whether the specified name is fully qualified (“x.y.z”), partially qualified (“y.z”), or unqualified (“z”). Examples of by-Name object dependencies include view and user defined function definitions that refer to a source table. As a more specific example of by-Name object dependency, a view V can be created by the following statement:

CREATE VIEW V AS SELECT*FROM Sch. T;
These types of dependencies are specified by the partial/full qualified name of the referenced object in the referencing object's definition where the definition is a SQL expression. Objects such as views, policies, functions, and procedures are examples that fall into this category.

With a by-ID dependency, a referencing object stores an identifier of a referenced object as a dependency. Generally, this dependency is stored as a specific field in metadata of the referencing object that stores the ID of the referenced object. As an example, an external table with a by-ID dependency on a stage includes an identifier of the stage in a specific field of the metadata for the table.

As shown in FIG. 4, the dependency collector 230 works in conjunction with the compiler 402 and detects the object dependency created based on the command. The dependency validator 232 analyzes the object dependency to determine a state of the dependency. More specifically, the dependency validator 232 determines whether the dependency is valid or invalid (also referred to herein as “broken”), which are two possible states for an object dependency. The dependency collector 230 creates a dependency record 404 based on the detected object dependency and the state of the dependency.

A metadata exporter 406 of the multi-tenant service manager 108 exports the dependency record 404 to a dependency record database 408. The dependency record database 408 can store multiple dependency records for multiple objects maintained by the multi-tenant cloud-based database system 102. A dependency table 410 can be created from a set of dependency records within the dependency record database 408. An object dependency view 412 can be created from the table 410 to present dependency information for one or more objects. In an example, the object dependency view 412 corresponds to a specific object and provides dependency information for the object that specifies dependencies of the objects, dependencies on the object, or a combination of both.

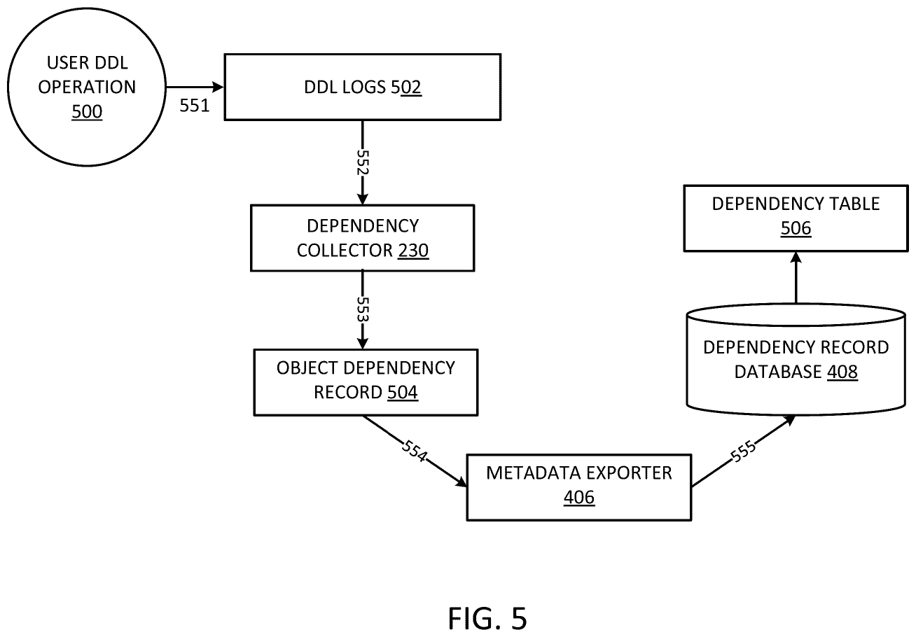

FIG. 5 is a block diagram illustrating aspects of the dependency management system 228 in the multi-tenant cloud-based database system 102, in accordance with aspects of this disclosure. As shown, a user performed DDL operation 500 (e.g., create, drop, or update) is logged 551 and included in DDL logs 502. The DDL operation results in the creation of an object dependency. The dependency collector 230 analyzes 552 the DDL logs 502 and identifies the object dependency created based on the DDL operation 500. Based on the detected object dependency, the dependency collector 230 generates 553 a dependency record 504 and stores the dependency record 504 in an intermediate database used to store records before exporting 554 them to the dependency record database 408. The metadata exporter 406 periodically accesses 555 the dependency records from the intermediate database and exports the records to the dependency record database 408. A table 506 can be created from a set of dependency records within the dependency record database 408.

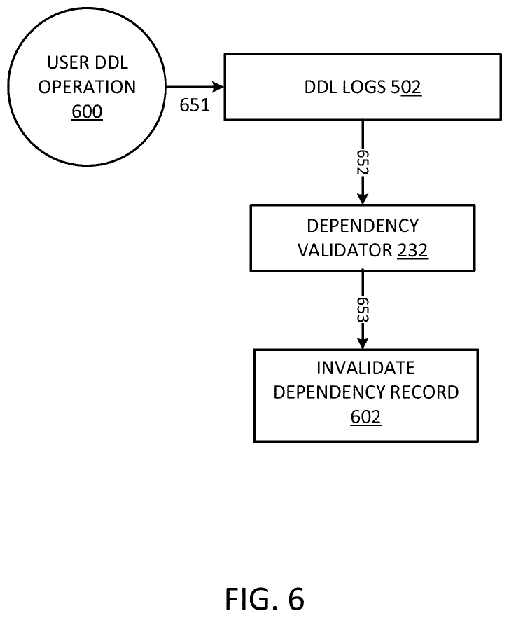

FIG. 6 is a block diagram illustrating aspects of the dependency management system 228 in the multi-tenant cloud-based database system 102, in accordance with aspects of this disclosure. As shown, a user performs a DDL operation 600 (e.g., create, drop, or update) on a first object with an existing dependency on a second object. The DDL operation 600 results in a change to either the first or second object. The DDL operation 600 is logged and added 651 to the DDL logs 502. The dependency validator 232 accesses 652 the DDL log 502 and detects the change to the first or second object resulting from the DDL operation 600. The dependency validator 232 analyzes whether the change results in the object dependency between the first and second object being broken (invalid). Based on determining that the change results in the object dependency being invalid, the dependency validator 232 invalidates 653 the corresponding dependency record, at 602. In doing so, the dependency validator 232 changes the state of the dependency indicated in the dependency record from “valid” to “broken.”

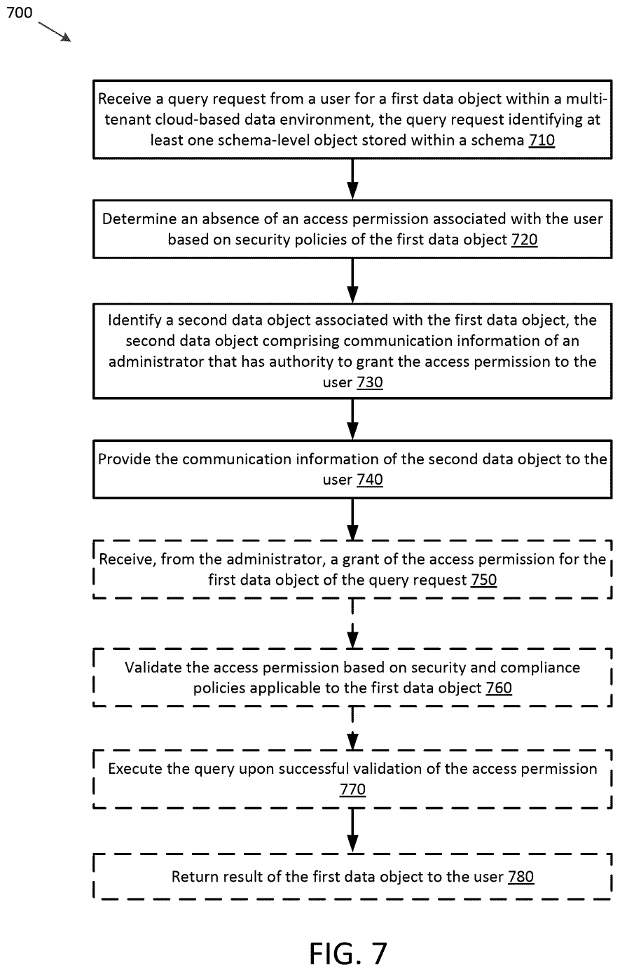

FIG. 7 is a flow diagram illustrating operations in performing a method 700 for granting data user permissions using a contact data model (also referred to as “contact(s)” herein), in accordance with aspects of this disclosure. The method 700 may be embodied in computer-readable instructions for execution by one or more hardware components (e.g., one or more processors coupled with one or more non-transitory memories) such that the operations of the method 700 may be performed by components of multi-tenant cloud-based database system 102, as described in FIG. 1. In addition, the method 700 may be deployed on various other hardware configurations and is not intended to be limited to deployment within the multi-tenant cloud-based database system 102.

The method 700 begins, at 710, with receiving a query request from a user for a first data object within the multi-tenant cloud-based data environment, such as the multi-tenant cloud-based data environment 100 of FIG. 1. The query request identifies at least one schema-level object stored within a schema, such as the query 400 of FIG. 4.

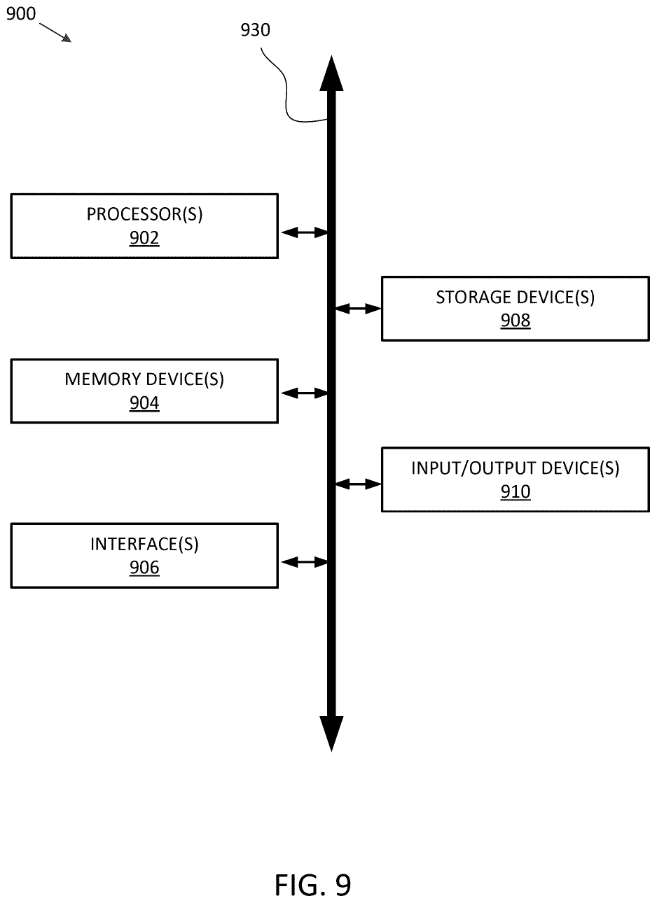

At 720, a processor (such as the processor 902 of FIG. 9) of a cloud-based database system of the multi-tenant data environment determines an absence of an access permission associated with the user based on security policies of the first data object.

At 730, the processor identifies a second data object (e.g., a contact object) associated with the first data object. The second data object includes communication information of an administrator that has authority to grant the access permission to the user. Examples of different administrators of different persona or roles are described below.

In some embodiments, the second data object is a schema level object. The second data object may be referred to as “contact” object. The communication information may include at least one of: an identification information of the administrator, a communication non-transitory computer-readable medium (e.g., a communication channel) for reaching the administrator, or a network reception or destination information of the administrator.

In some cases, the second data object is associated with two or more different data objects, including the first data object. The second data object is visible to the user when the user is authorized to access metadata of at least one of the two or more different data objects.

At 740, the communication information of the second data object is provided to the user. For example, the communication information may be displayed or transmitted to the user via various output interfaces (such as the input/output device(s) 910 of FIG. 9).

At 750, a grant of the access permission is received from the administrator for the first data object of the query request. For example, the grant may be processed at one or more of the access manager 202, the key manager 204, or the contact manager 252 of FIG. 2. At 760, the access permission is validated based on security and compliance policies applicable to the first data object. For example, the validation may be processed at the dependency validator 232 of FIGS. 2, 4, and 6. At 770, the processor executes the query upon successful validation of the access permission. For example, the execution may include one or more operations described in relation to FIG. 4. At 780, the processor returns the query execution result of the first data object to the user.

In some embodiments, data end users may have functional roles as data analysts, scientists, engineers, business intelligence analysts, etc. A data end user may find a database object (the first data object) but does not have access to query the object. The data end user may utilize method 700 to learn about the individual or team information from the second data object (i.e., the contact object). The data end user then requests access and may be granted access. The method 700 enables the data end user to find objects even if the data end user does not have the privilege to query the first data object. In some cases, the first data object may include an organizational listing.

In some embodiments, data owners and/or listing creators may have roles as data analysts, product managers, data engineers, etc. A data owner or listing creator may proactively provide the communication information for consumer data users to request access permissions when appropriate (e.g., meeting policy and security requirements). In some cases, the data owner may use a default communication profile (as content for the communication information) to associate with data listings. The data owner may also indicate the availability of such communication information to the end users via the contact objects.

In some embodiments, a data steward may use the method 700 to manage multiple objects within a common schema. The data steward may associate a default contact objects with various objects under a common stewardship. Similarly, an administrator responsible for the health of the cloud-based database system may use the method 700 to route account-level notifications to team members (e.g., via the contact object).

In some embodiments, a native application provider may use the method 700 to obtain notification when a security scan for a version or patch has been completed for native application releases. The notification may be triggered and received when the communication information is provided 740 to an associated query request from an application deployment. A native application consumer may also use method 700 to receive notifications regarding application lifecycle events, such as installation/update completions and/or configurations for updates or upgrades. Using the contact objects, an application owner may also use the method 700 to request assistance from account administrators for various operations, including granting privileges, binding references to objects, and/or reassigning ownership of external databases owned by an application (e.g., to avoid losing data in various situations).

In some embodiments, data users are provided with valid and current contact information in the contact object. The contact objects may have consistent behavior as other data object types and have characteristics for objects both within the same account as well as shared across accounts. The contact objects may be created by the contact creator 254 and distributed by the contact distributor 256 of FIG. 2. Creating and associating/distributing contacts can be performed by at least one of: individual owners, stewards with oversight of multiple logically grouped objects, or centralized administrators responsible for the account.

In some embodiments, a highly privileged central administrator needs not configure contact objects for everyone in an organization to use. For example, with the association to contact objects, user privileges or permissions may be optimized for creating, discovering, or associating contacts with data objects or listings (with different requirements for internal listings or the like). The communication information provided in the contact objects may have tags or metadata associations to meet security and policy compliance requirements and to avoid being characterized as spams, subject to user preferences.

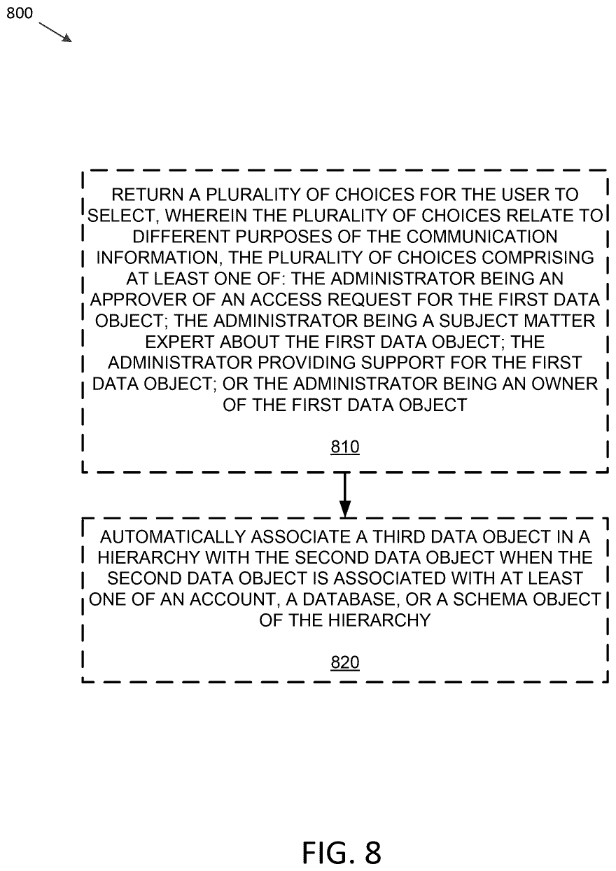

FIG. 8 is a flow diagram illustrating additional operations in performing a method 800 complementing the method 700, in accordance with aspects of this disclosure. As shown, the method 800 includes returning 810 multiple choices for the user to select when providing the communication information. The multiple choices relate to different purposes of the communication information. For example, the multiple choices include at least one of: the administrator being an approver of an access request for the first data object; the administrator being a subject matter expert about the first data object; the administrator providing support for the first data object; or the administrator being an owner of the first data object.

The method 800 further includes automatically associating 820 a third data object in a hierarchy with the second data object when the second data object is associated with at least one of an account, a database, or a schema object of the hierarchy.

Referring to both methods 700 and 800, in some embodiments, the second data object includes at least a username, an email address or distribution list, and a communication method. Each contact object may be defined with at least one of the following purposes: an access approver, a subject matter expert, a support contact, or a default or owner contact. The contact object may specify the technical details of the communication channel through which the contact individual or team may be reached. In some cases, for validation purposes, a given object and purpose combination may be set with one contact object only. In some cases, a contact object indicating default or steward purposes may not be assigned to a data listing or profile.

In some embodiments, contact objects associated with a database or schema object is automatically inherited by all data objects in the hierarchy. In some cases, a special purpose may be default for all purposes. For contact objects having specific purposes, the specific purposes may be inherited by the following order: the contact with the specific purpose if the contact is set on the object; the contact with the default purpose if the contact is set on the object; the contact with the specific purpose on the parent object with a specific contact set on the parent object; and the contact with the specific purpose on the parent object with a default contact set on the parent object.

In some embodiments, when an end user is enabled to view the data object metadata (e.g., name, columns, etc.) the end user is also enabled to view the communication information of the contact object associated with the data object. The end user, however, may not view higher level properties such as the contact object name, or the schema name of the data object.

FIG. 9 is a block diagram of an example computing device 900 that may perform one or more of the operations described herein, in accordance with some embodiments. Computing device 900 may be connected to other computing devices in a LAN, an intranet, an extranet, and/or the internet. The computing device may operate in the capacity of a server machine in a client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 900 may include a processor(s) 902 (e.g., a general purpose processing device, a central processing unit (CPU), a graphical processing device (GPU), a programmable logic device (PLD), etc.), a memory device(s) 904 (e.g., synchronous dynamic random access memory (DRAM), read-only memory (ROM)), a static memory (e.g., flash memory), an interface(s) 906, a data storage device 908, and input/output devices 910, all of which may communicate with each other via a bus 930.

Processing device 902 may be provided by one or more general-purpose processing devices such as a microprocessor, central processing unit, or the like. In an illustrative example, processing device 902 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 902 may also include one or more special-purpose processing devices such as an application specific integrated circuit (ASIC), a field programmable gate array (FPGA), a digital signal processor (DSP), network processor, or the like. The processing device 902 may be configured to execute the operations described herein, in accordance with one or more aspects of the present disclosure, for performing the operations and steps discussed herein. In one embodiment, processing device 902 represents a processing device of cloud computing platform 100 of FIG. 1.

The network interface device 906 may communicate with a network or other computing devices (not shown), such as via the internet, cellular network, or local short-range networks. Communication may be implemented using a wide variety of technologies. The Input/output device(s) 910 may include communication components operable to couple the computing device 900 to a network or one or more user terminals (e.g., user equipment, or UE). For example, the communication components may include a network interface component or another suitable device to interface with the network. In some examples, the communication components may include wired communication components, wireless communication components, cellular communication components, and other communication components to provide communication via other modalities. The one or more user terminals may be another machine or any of a wide variety of peripheral devices (e.g., a peripheral device coupled via a universal serial bus (USB)). For example, as noted above, the computing device 900 may correspond to any one of the multi-tenant service manager 108, the execution platform 110, and the one or more user terminals may include the data storage device 206 or any other computing device described herein as being in communication with the multi-tenant cloud-based database system 102 or the storage platform 104.

The data storage device 908 may include a computer-readable storage medium on which may be stored one or more sets of instructions, such as instructions for executing a query processing component, e.g., instructions for carrying out the operations described herein, in accordance with one or more aspects of the present disclosure. Query processing instructions may also reside, completely or at least partially, within memory devices 904 and/or within processing device 902 during execution thereof by computing device 900, the memory devices 904 and processing device 902 also constituting computer-readable media. The instructions may further be transmitted or received over a network via the network interface device 906.

The input/output devices 910 may include a video display unit (e.g., a liquid crystal display (LCD) or a cathode ray tube (CRT)), an alphanumeric input device (e.g., a keyboard), a cursor control device (e.g., a mouse) and an acoustic signal generation device (e.g., a speaker). In one embodiment, video display unit 910, alphanumeric input device, and cursor control device may be combined into a single component or device (e.g., an LCD touch screen).

While computer-readable storage medium may be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “executing,” “selecting,” “determining,” “returning,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “includes,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods 700 and 800 may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of this disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of this disclosure may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned (including via virtualization) and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud). The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It will also be noted that each block of the block diagrams or flow diagrams, and combinations of blocks in the block diagrams or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A system comprising:
a memory; and
a processing device operatively coupled to the memory, the processing device to:
receive a query request from a user for a first data object within a multi-tenant cloud-based data environment, the query request identifying at least one schema-level object stored within a schema;
determine an absence of an access permission associated with the user based on security policies of the first data object;
identify a second data object associated with the first data object, the second data object comprising communication information of an administrator that has authority to grant the access permission to the user; and
provide the communication information of the second data object to the user.

2. The system of claim 1, wherein the processing device is further to:
receive, from the administrator, a grant of the access permission for the first data object of the query request;
validate the access permission based on security and compliance policies applicable to the first data object;
execute the query upon successful validation of the access permission; and
return result of the first data object to the user.

3. The system of claim 1, wherein the second data object is a schema level object and wherein the communication information comprises at least one of: an identification information of the administrator, a communication non-transitory computer-readable medium for reaching the administrator, or a network reception or destination information of the administrator.

4. The system of claim 1, wherein the processing device is to provide the communication information of the second data object to the user by:
returning a plurality of choices for the user to select, wherein the plurality of choices relate to different purposes of the communication information, the plurality of choices comprising at least one of:
the administrator being an approver of an access request for the first data object;
the administrator being a subject matter expert about the first data object;
the administrator providing support for the first data object; or
the administrator being an owner of the first data object.

5. The system of claim 1, wherein the processing device is further to:
automatically associate a third data object in a hierarchy with the second data object when the second data object is associated with at least one of an account, a database, or a schema object of the hierarchy.

6. The system of claim 3, wherein the second data object is associated with two or more different data objects, including the first data object.

7. The system of claim 6, wherein the second data object is visible to the user when the user is authorized to access metadata of at least one of the two or more different data objects.

8. A method comprising:
receiving a query request from a user for a first data object within a multi-tenant cloud-based data environment, the query request identifying at least one schema-level object stored within a schema;
determining an absence of an access permission associated with the user based on security policies of the first data object;
identifying, by a processing device, a second data object associated with the first data object, the second data object comprising communication information of an administrator that has authority to grant the access permission to the user; and
providing the communication information of the second data object to the user.

9. The method of claim 8, further comprising:
receiving, from the administrator, a grant of the access permission for the first data object of the query request;
validating the access permission based on security and compliance policies applicable to the first data object;
executing the query upon successful validation of the access permission; and
returning result of the first data object to the user.

10. The method of claim 8, wherein the second data object is a schema level object and wherein the communication information comprises at least one of: an identification information of the administrator, a communication method for reaching the administrator, or a network reception or destination information of the administrator.

11. The method of claim 8, wherein providing the communication information of the second data object to the user comprises:
returning a plurality of choices for the user to select, wherein the plurality of choices relate to different purposes of the communication information, the plurality of choices comprising at least one of:
the administrator being an approver of an access request for the first data object;
the administrator being a subject matter expert about the first data object;
the administrator providing support for the first data object; or
the administrator being an owner of the first data object.

12. The method of claim 8, further comprising:
automatically associating a third data object in a hierarchy with the second data object when the second data object is associated with at least one of an account, a database, or a schema object of the hierarchy.

13. The method of claim 10, wherein the second data object is associated with two or more different data objects, including the first data object.

14. The method of claim 13, wherein the second data object is visible to the user when the user is authorized to access metadata of at least one of the two or more different data objects.

15. A non-transitory computer-readable medium having instructions stored thereon which, when executed by a processing device, cause the processing device to:
receive a query request from a user for a first data object within a multi-tenant cloud-based data environment, the query request identifying at least one schema-level object stored within a schema;
determine an absence of an access permission associated with the user based on security policies of the first data object;
identify, by the processing device, a second data object associated with the first data object, the second data object comprising communication information of an administrator that has authority to grant the access permission to the user; and
provide the communication information of the second data object to the user.

16. The non-transitory computer-readable medium of claim 15, wherein the processing device is further to:
receive, from the administrator, a grant of the access permission for the first data object of the query request;
validate the access permission based on security and compliance policies applicable to the first data object;
execute the query upon successful validation of the access permission; and
return result of the first data object to the user.

17. The non-transitory computer-readable medium of claim 15, wherein the second data object is a schema level object and wherein the communication information comprises at least one of: an identification information of the administrator, a communication non-transitory computer-readable medium for reaching the administrator, or a network reception or destination information of the administrator.

18. The non-transitory computer-readable medium of claim 15, wherein the processing device is to provide the communication information of the second data object to the user by:
returning a plurality of choices for the user to select, wherein the plurality of choices relate to different purposes of the communication information, the plurality of choices comprising at least one of:
the administrator being an approver of an access request for the first data object;
the administrator being a subject matter expert about the first data object;
the administrator providing support for the first data object; or
the administrator being an owner of the first data object.

19. The non-transitory computer-readable medium of claim 15, wherein the processing device is further to:
automatically associate a third data object in a hierarchy with the second data object when the second data object is associated with at least one of an account, a database, or a schema object of the hierarchy.

20. The non-transitory computer-readable medium of claim 17, wherein the second data object is associated with two or more different data objects, including the first data object.
